(19) United States
(12) Patent Application Publication
(10) Pub. No.: US 2014/0225305 A1
(43) Pub. Date: Aug. 14, 2014

(54) HOLLOW OVERLAY MOLDING PROCESS AND SYSTEM

(71) Applicant: Windsor Mold Inc., Windsor (CA)

(72) Inventors: Patrick Martyn, Windsor (CA); Bradd Maisonville, Windsor (CA)

(73) Assignee: WINDSOR MOLD INC., Windsor (CA)

(21) Appl. No.: 14/168,124

(22) Filed: Jan. 30, 2014

Related U.S. Application Data
(60) Provisional application No. 61/764,282, filed on Feb. 13, 2013.

(51) Int. Cl. B29D 23/00

(52) U.S. Cl. CPC B29D 23/00
USPC 264/250; 425/588

(57) ABSTRACT

A molding apparatus has a first top assembly which includes a first, a second, and a third top molding station; and a bottom assembly which includes a first, a second, and a third bottom molding station. The top and bottom assemblies may be repositioned relative to one another so that in a first configuration the first, second, and third top stations are engaged with the first, second, and third bottom stations; and in a second configuration the first top and second bottom stations are engaged, the second top and third bottom stations are engaged, and the third top and first bottom stations are engaged. Further disclosed is an injection molding process carried out utilizing the apparatus.

### CROSS-REFERENCE TO RELATED APPLICATIONS

This application claims priority of provisional application Ser. No. 61/764,282, filed Feb. 13, 2013, and entitled “Hollow Overlay Molding Process and System” which application is incorporated herein by reference.

### FIELD OF THE INVENTION

This invention relates to molding processes and equipment, more particularly to an injection molding process for fabricating hollow articles.

### BACKGROUND OF THE INVENTION

A large number of hollow articles, such as fuel tanks, bottles, and other containers, are fabricated from polymeric materials. Typically, such hollow articles are manufactured by a blow molding process. However, blow molding processes are often limited in terms of materials which may be employed, and in product configurations which are achievable. In addition, blow molding processes tend to have slow cycle times. Consequently, the industry has been looking for alternatives for the fabrication of hollow articles.

Injection molding processes are reliable and capable of providing precisely controlled geometries; however, it has been found difficult to fabricate closed cross-section, hollow articles, such as tanks, tubes, or other containers, by utilizing injection molding techniques. In some instances, a process referred to as “Die Slide Molding” has been employed for the injection molding of hollow articles; however, this process requires some very specialized equipment and has a slow cycle time since the die slide process molding equipment must go through two separate opening/closing cycles to make each finished part.

As will be explained in detail hereinbelow, the present invention is directed to an injection molding process and apparatus which employs a series of mutually movable die parts configured for the fabrication of hollow articles. The process of the present invention carries out several steps in conjunction, and is capable of producing a finished part with every single cycle of the molding apparatus. It should be noted that the hollow overlay molding process of the present invention also allows for the formation of internal details in the molded product, and this is a significant improvement over prior art processes such as blow molding, which do not have this capability. These and other features of the present invention will be apparent from the drawings, description, and discussion which follow.

### BRIEF DESCRIPTION OF THE INVENTION

Disclosed herein is a molding apparatus comprising a top assembly having a first top injection molding station which has mold features corresponding to a top portion of an article to be molded, a second top injection molding station, and a third top injection molding station also corresponding to a top portion of the article to be molded. The apparatus further includes a bottom assembly having a first bottom injection molding station, a second bottom injection molding station, and a third bottom injection molding station each of which correspond also corresponding to a bottom portion of the article to be molded. The apparatus is configured and operative so that the top assembly and the bottom assembly may be selectably repositioned relative to one another, so that the apparatus is operable in a first and second configuration. In the first configuration the first top station is engageable with the first bottom station, the second top station is engageable with the second bottom station, and the third top station is engageable with the third bottom station. In the second configuration the first top station is engageable with the second bottom station, the second top station is engageable with the third bottom station, and the third top station is engageable with the first bottom station. In particular instances, the second top station of the top assembly corresponds to a bottom portion of the article to be molded and/or the first bottom station corresponds to a top portion of the article to be molded. Other embodiments of the apparatus may include additional molding stations. Further disclosed are injection molding processes utilizing the disclosed apparatus, as well as articles manufactured in the processes.

### BRIEF DESCRIPTION OF THE DRAWINGS

FIG. 1A is a perspective view of an article which may be manufactured utilizing the apparatus and method of the present invention;

FIG. 1B is an exploded view of the article of FIG. 1A;

FIG. 2 is a schematic depiction of a molding apparatus of the present invention as disposed in a first configuration for carrying out a first step of a molding process of the present invention;

FIG. 3 is a depiction of the apparatus of FIG. 2 in a further step of the process wherein top and bottom assemblies of the apparatus are separated;

FIG. 4 shows the apparatus of FIG. 3 having a finished part ejected therefrom;

FIG. 5 shows the apparatus of the present invention wherein top and bottom assemblies are rotated to a second configuration;

FIG. 6 shows an apparatus in accord with FIG. 5 wherein the top and bottom assemblies are engaged and a molding step is being carried out;

FIG. 7 shows an apparatus in the configuration of FIG. 6 wherein the top and bottom assemblies have been separated;

FIG. 8 shows the apparatus in the configuration of FIG. 7 wherein a finished part is being ejected therefrom;

FIG. 9 shows the apparatus of the present invention wherein the bottom assembly thereof is rotated so as to restore the apparatus to a first configuration;

FIG. 10 shows the apparatus in the configuration of FIG. 9 wherein the top and bottom assemblies are engaged so as to complete a molding cycle; and

FIG. 11 shows a portion of a finished article incorporating particular molded features in accord with the present invention.

### DETAILED DESCRIPTION OF THE INVENTION

The present invention utilizes a molding apparatus comprising a top assembly having a first top station which has mold features corresponding to a top portion of an article to be molded, as well as a second top station, and a third top station also corresponding to a top portion of the article to be molded. The apparatus also includes a bottom assembly having a first bottom station, a second bottom station, and a third bottom station each of which correspond to a bottom portion of the article to be molded. The apparatus is configured so that the top assembly and the bottom assembly may be selectably repositioned relative to one another so that the apparatus may be operable in a first and second configuration. In the first configuration the first top station is engageable with the first bottom station, the second top station is engageable with the second bottom station, and the third top station is engageable with the third bottom station. In the second configuration the first top station is engageable with the second bottom station, the second top station is engageable with the third bottom station, and the third top station is engageable with the first bottom station.

In the molding process the top and bottom assemblies are disposed in the first configuration, and a top portion of a first article is injection molded in the first top station and a bottom portion of a first article is injection molded in the second bottom station. In the next step, the top and bottom stations are moved to the second configuration so that the top portion and the bottom portion of the first article previously molded are engaged. A sealing material is usually injection molded between the top and bottom portions so as to seal them together and form the first article. Further in accord with the invention, a top portion of a second article is injection molded in the third top station and a bottom portion of the second article is injection molded in the third bottom station. At this point, the top and bottom assemblies are separated and the first article is ejected from the apparatus.

Following that, the top and bottom assemblies are moved back to the first configuration so that the top portion and the bottom portion of the second article previously molded are engaged. Again, a sealing material is typically injection molded therebetween so as to seal the top and bottom portions and form the second article. In this step, a top portion of a third article is injection molded in the first top station and a bottom portion of the third article is injection molded in the second bottom station. The top and bottom assemblies are again separated and the second article is ejected from the apparatus. The process is sequentially repeated with regard to the third and subsequent articles.

The present invention may be implemented with regard to a variety of articles and variously configured molding apparatus; and one generalized apparatus, process, and molded product are described herein. Other embodiments and implementations of the invention will be apparent therefrom to those of skill in the art.

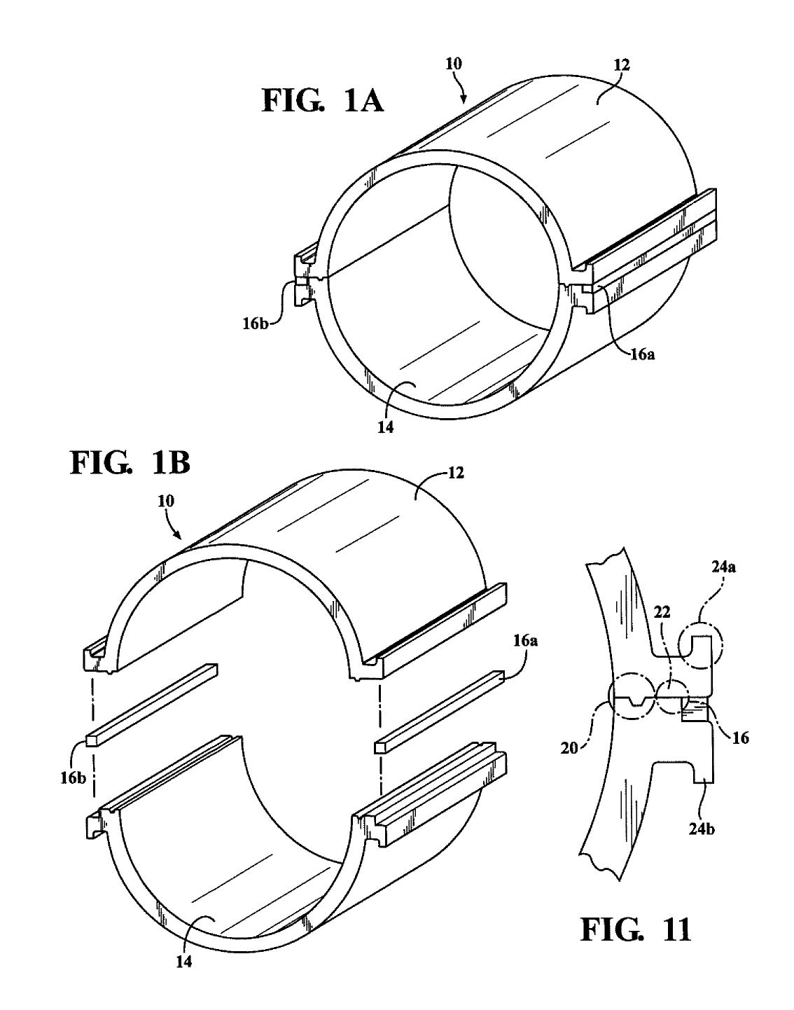

FIGS. 1A and 1B show, respectively, perspective and exploded views of a generalized hollow article 10 of the type which may be manufactured in the apparatus and process of the present invention. The article 10 of FIGS. 1A and 1B is shown as a hollow cylinder, although it is to be understood that this article could comprise a completely closed hollow article as well as a partially closed article such as a fuel tank, container, heating duct, or the like. As shown, the article comprises a top portion 12, a bottom portion 14, and sealing members 16a, 16b which cooperate to seal the top 12 and bottom 14 portions together. The various components are fabricated from a polymeric material which is capable of being injection molded, and the components may be of similar or different compositions depending upon particular applications. It is to be understood that in particular instances, the separate sealing members, 16a, 16b may be dispensed with, and the two portions of the article may be joined by fusion bonding, ultrasonic welding, adhesives, or the like.

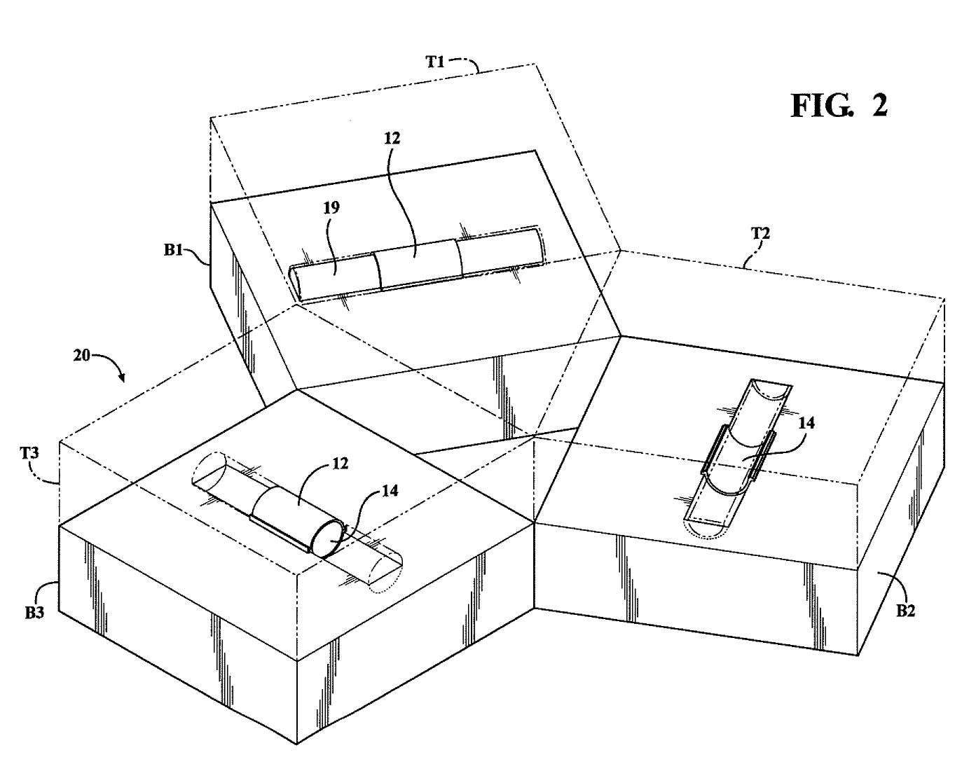

Referring now to FIG. 2, there is shown a generalized depiction of a molding apparatus 20 of the present invention. The apparatus includes a top assembly comprised of three stations T-1, T-2, and T-3. Station T-1 defines a shape corresponding to a top portion 12 of an article to be molded. Station T-3 likewise corresponds to a top portion of the article to be molded. Station T-2 need not correspond to a top portion, but in this particular implementation it is configured to cooperate with a second bottom station B-2, which will be described in detail hereinbelow, so as to define a bottom portion 14 of the article.

The apparatus 20 includes a bottom assembly comprised of a first bottom station B-1, a second bottom station B-2, and a third bottom station B-3. As mentioned above, the second bottom station B-2 defines a bottom portion 14 of the article, and in this instance the T-2 top portion cooperates with station B-1 to define this portion. As such, T-2 has a convex surface which, in the use of the system, projects into the concave portion of station B-2 and defines the inner surface of the bottom portion 14 of the article being molded. Bottom station B-3 likewise defines a bottom portion 14 and sealing members 16a, 16b of the article.

Bottom station B-1 in this particular instance is configured so as to cooperate with top station T-1 so as to define the top portion 12 of the article. As such, B-1 has a convex surface 19, which in the use of the system, projects into the concave portion of station T-1 and defines the inner surface of the upper portion 12 of the article being molded. It is to be understood that in other implementations B-1 and/or T-2 need not be configured so as to cooperate with their respective mating portions. As noted above, the top assembly and bottom assembly are repositionable relative to one another, typically by rotating either the top or the bottom assembly so as to displace the apparatus from a first configuration to a second configuration.

FIG. 2 shows the apparatus in a first configuration wherein T-1 is engaged with B-1, T-2 is engaged with B-2, and T-3 is engaged with B-3, and illustrates the method of the present invention at a stage in which a top portion 12 of the article is injection molded in station T-1 and a bottom portion 14 of an article is injection molded in station B-2. These injection molding steps may be carried out simultaneously or separately, utilizing injection molding methods and materials as are known, or come to be known, in the art. In the FIG. 2 configuration, a previously molded top portion 12 and bottom portion 14 of an article are disposed in respective T-3 and B-3 stations, in an engaged relationship, and a sealant material is injection molded thereinto so as to form the sealing bodies 16a and 16b shown in FIG. 1. The sealant material may comprise the same material used for the injection molding of the top and bottom portions or may comprise a different material. In any instance, the sealant material bonds the top and bottom portions together thereby forming a completed article. As noted, the use of a sealant is optional, and the two portions of the article may be otherwise joined.

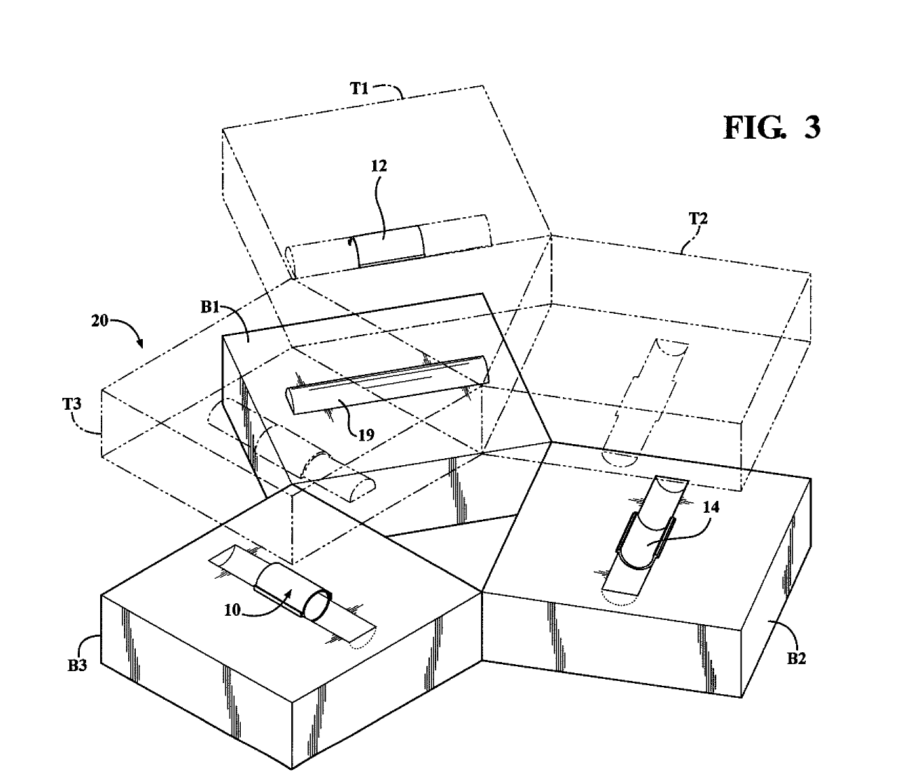

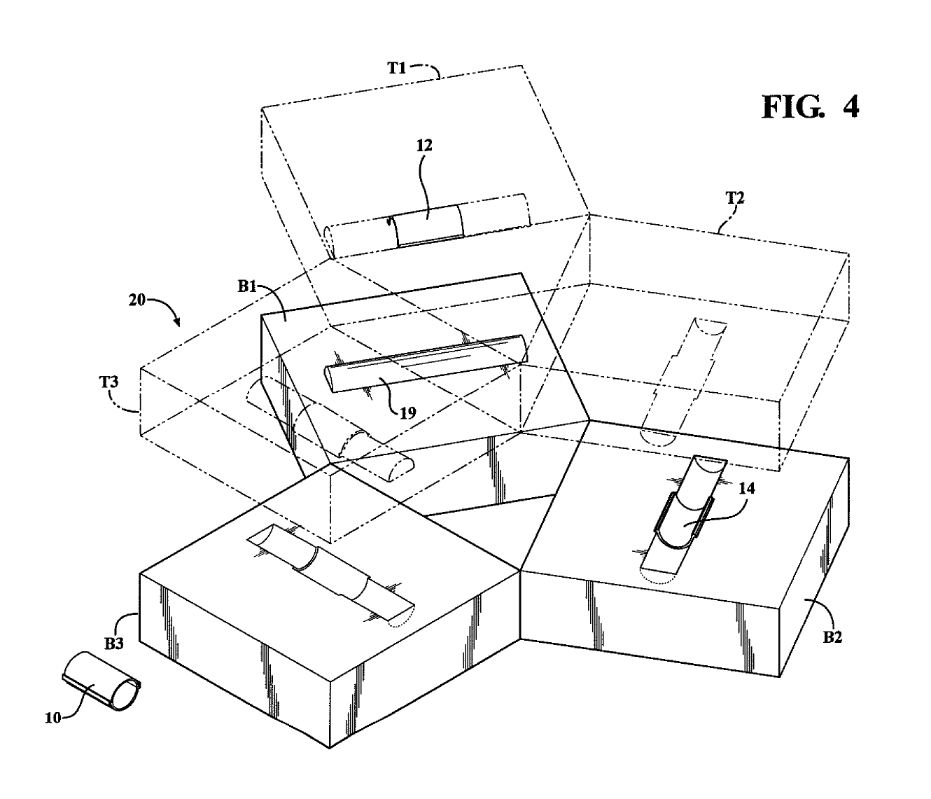

Referring now to FIG. 3, there is shown a further step in the process wherein the top assembly and bottom assembly are separated. In this step, the top part 12, previously molded in station T-1, and the bottom part 14, previously molded in station B-2, remain in their respective stations while the completed part 10 is ejected from stations T-3 and B-3 as is shown in FIG. 4.

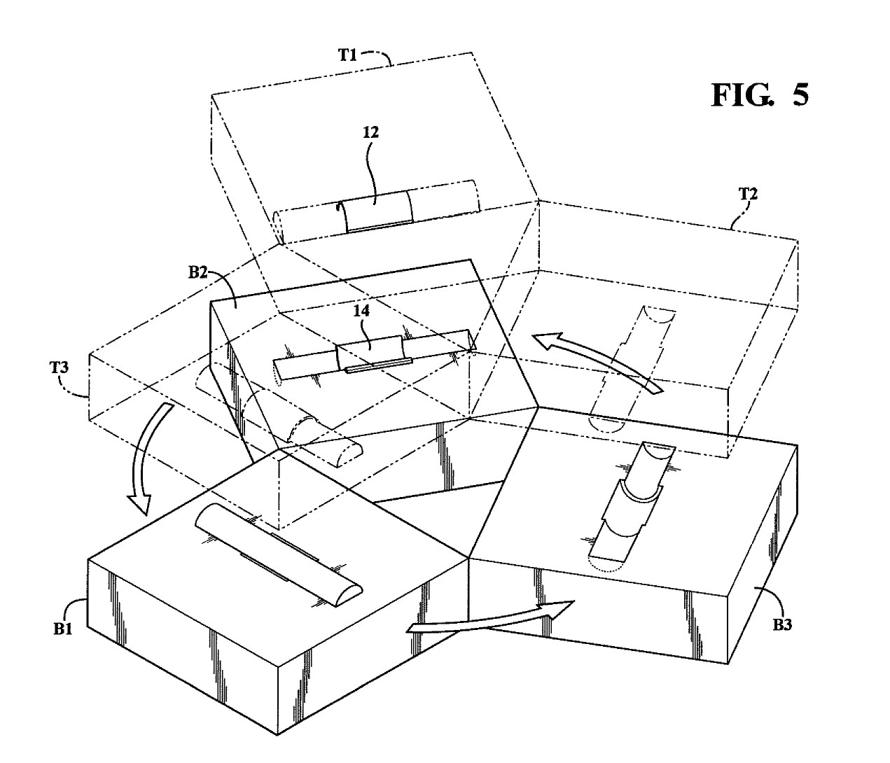

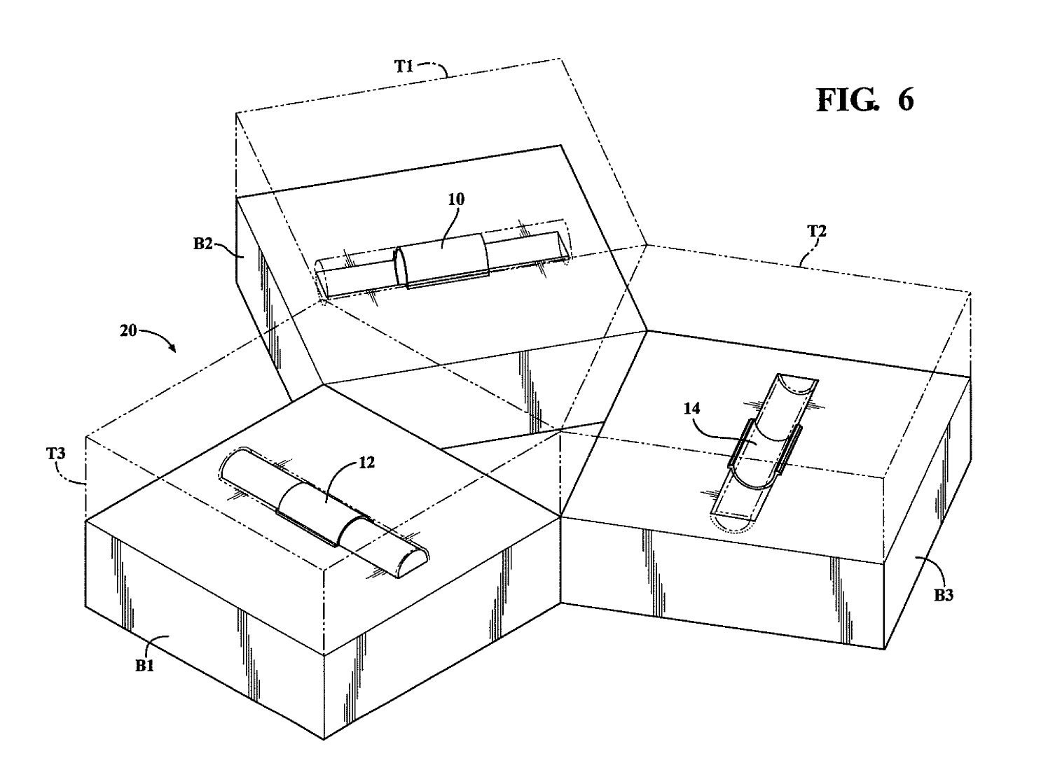

Referring now to FIG. 5, there is shown a further step in the present invention wherein the top and bottom assemblies are disposed in the second configuration. In this regard, the drawing of FIG. 5 shows the bottom assembly rotating so that the bottom portion 14 of the article molded in station B-2 is disposed beneath the top portion 12 of the article molded in station T-1. As shown in FIG. 6, the molding apparatus 20 is closed so that the previously molded top and bottom portions 12, 14 are engaged with one another by stations T-1 and B-2; further in this step, a sealant material is injected into the engaged portions in stations T-1 and B-2 so as to seal the top and bottom portions therein and define a second completed article 10. At this stage, as is further shown in FIG. 6, a second bottom portion 14 is molded in station B-3 and a corresponding top portion 12 is injection molded in station T-3.

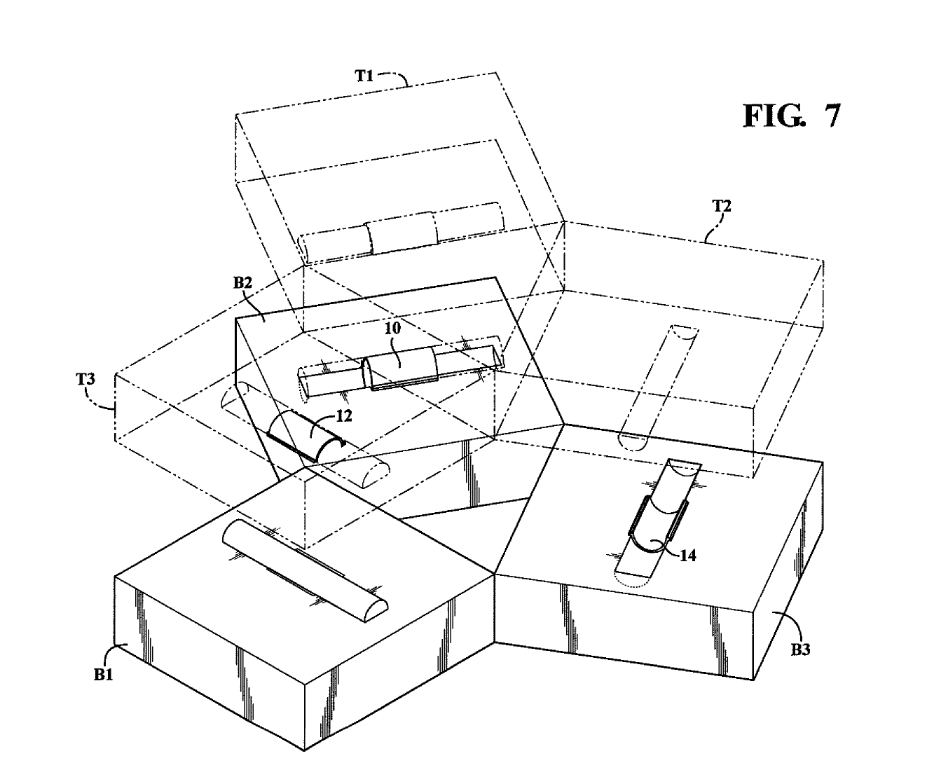

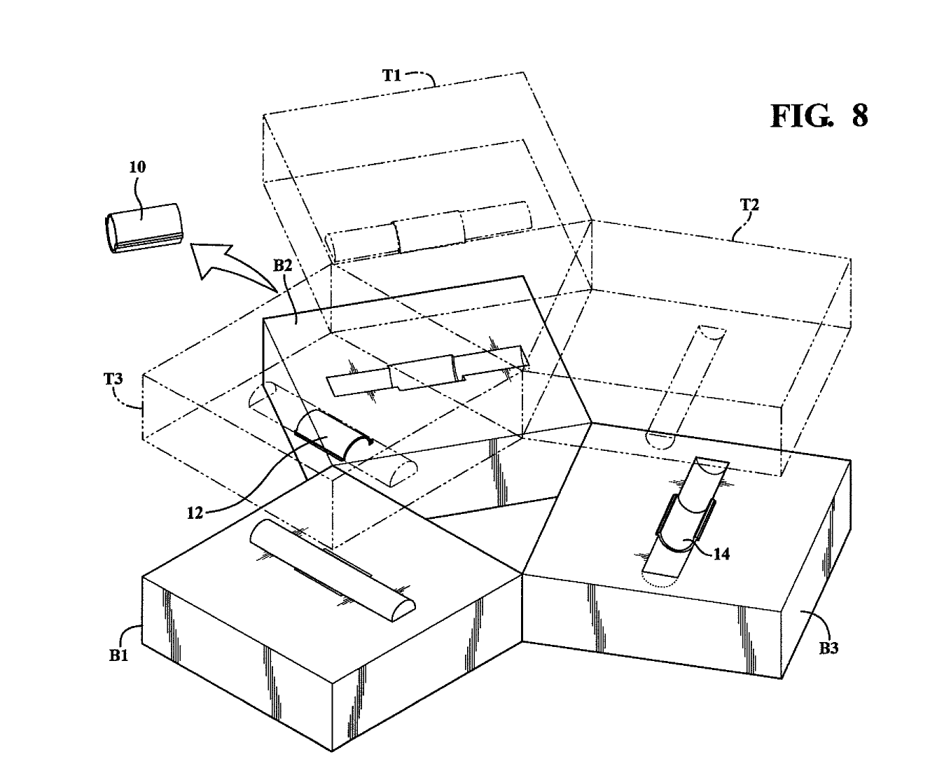

As shown in FIG. 7, the molding apparatus again opens so as to separate the top assembly from the bottom assembly. As shown in FIG. 8, the completed part 10 is ejected from the combination of stations T-1 and B-2 while the newly molded top portion 12 and bottom portion 14 remain with their respective stations T-3 and B-3.

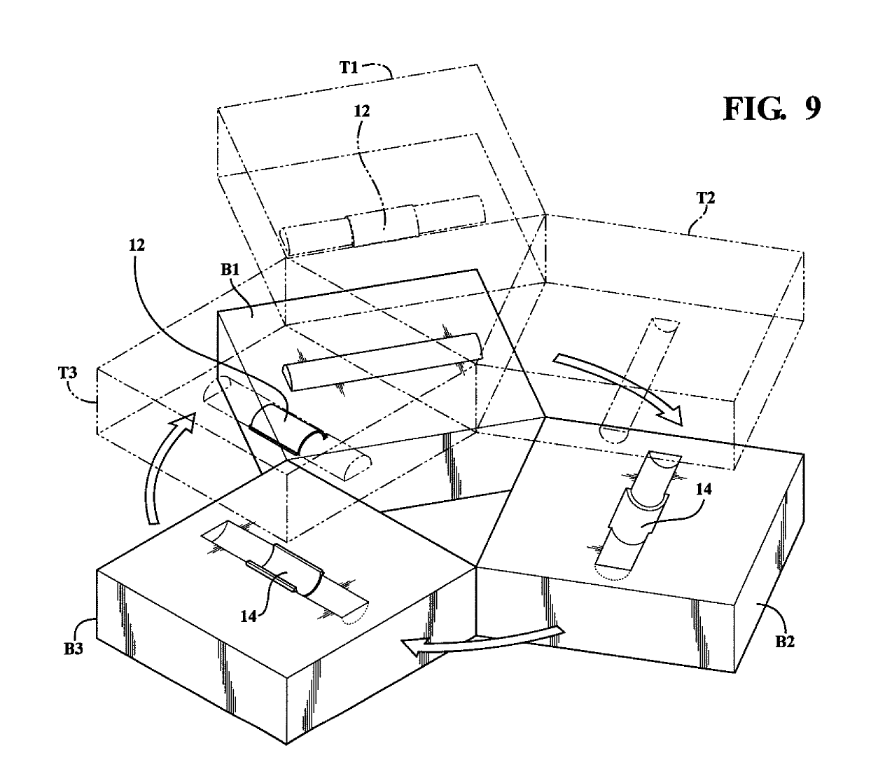

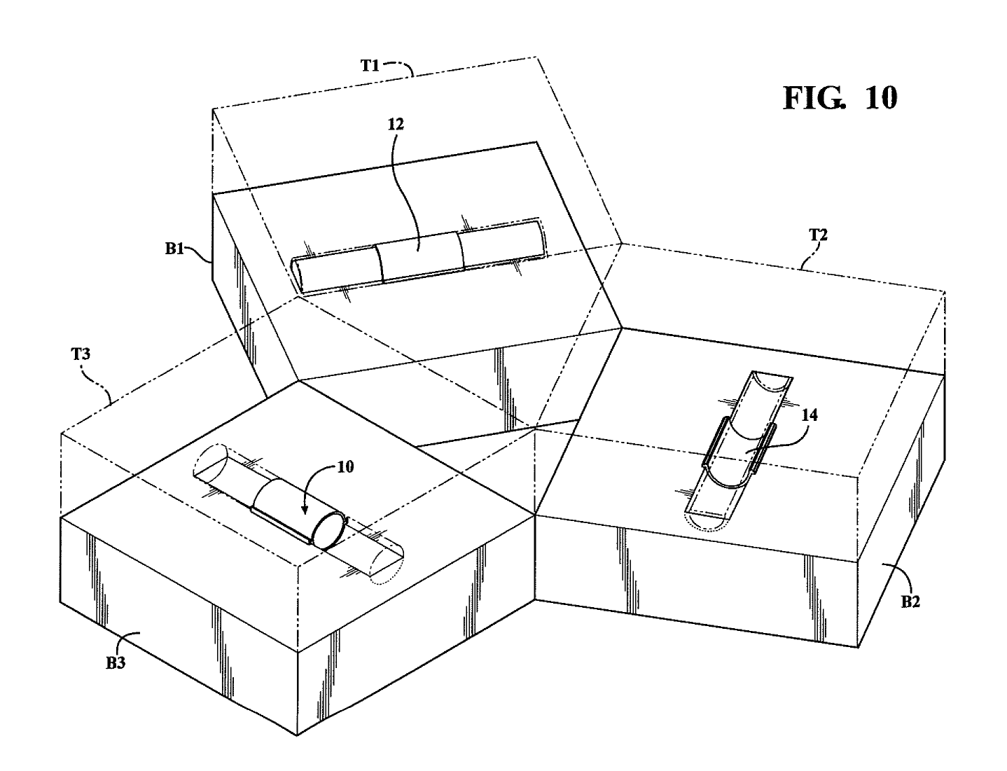

As shown in FIG. 9, the bottom assembly is again rotated so as to return the apparatus to its first configuration wherein T-1 is aligned with B-1, T-2 is aligned with B-2, and T-3 is aligned with B-3. As shown in FIG. 10, the apparatus is closed so as to engage the stations and return the apparatus to the configuration shown in FIG. 2. Thereafter, the process may be repeated as described with regard to FIGS. 2-9. It will be appreciated from the foregoing that the present apparatus is capable of producing one finished item with every open/close cycle of the apparatus.

It is to be understood that the apparatus may be implemented in other configurations. For example, the top and bottom assemblies may include a larger number of stations which appropriately index between first and second configurations so as to mold two or more articles for every open/close cycle. Also, it is to be understood that yet other injection-based molding techniques may be incorporated in conjunction with the process. For example, the system of the present invention may be implemented in conjunction with transfer molding processes or insert molding processes as are shown in U.S. Pat. Nos. 5,753,151 and 7,740,307, the disclosures of which are incorporated herein by reference Likewise, other molding processes, as are known, or come to be known, to those of skill in the art may be implemented in conjunction with the present invention.

Use of the injection molding process of the present invention allows for the fabrication of high quality precision parts, which allows for the incorporation of various sealing, strengthening, and/or alignment features in the articles being molded. For example, FIG. 11 shows some particular features which may be incorporated into hollow articles produced by the present invention so as to enhance the integrity and/or handling capabilities of the thus-produced articles. For example, a tongue-and-groove configuration 20 may be readily molded into the components. Likewise, the molds may be configured to build in a pre-load interference in a flat 22 of the bottom part, which will assure tight mating of the parts and prevent any bleed-through of the sealing material 16. Also, the molds may be configured to form ribs 24a, 24b on the molded parts. These ribs 24 can help hold the parts in alignment with the molds when the molds open and the parts cool and shrink. This can be important to assure alignment of the parts when the molds rotate and close in a new position. Other such modifications and variations will be apparent to those of skill in the art.

The foregoing drawings, discussion, and description are illustrative of some embodiments and implementations of the present invention. It is to be understood that other such modifications and variations will be apparent to those of skill in the art in view of the teaching presented herein. It is the following claims, including all equivalents, which define the scope of the invention.

1. A hollow overlay molding process for molding a multipart, hollow article, said process comprising:
A. providing a molding apparatus comprising:
a top assembly having a first top station corresponding to a top portion of an article to be molded; a second top station; and a third top station corresponding to a top portion of the article to be molded; and
a bottom assembly comprising a first bottom station; a second bottom station corresponding to a bottom portion of said article to be molded; and a third bottom station corresponding to a bottom portion of said article to be molded;
wherein said top assembly and said bottom assembly may be selectably repositioned relative to one another so that the molding apparatus may be disposed in:
a first configuration wherein said first top station is engageable with said first bottom station; said second top station is engageable with said second bottom station; and said third top station is engageable with said third bottom station; and
a second configuration wherein said first top station is engageable with said second bottom station; said second top station is engageable with said third bottom station; and said third top station is engageable with said first bottom station;
B. disposing said top and bottom assembly in said first configuration; injection molding a top portion of a first article in said first top station; and injection molding a bottom portion of said first article in said second bottom station;
C. disposing said top and bottom stations in said second configuration so that the top portion and the bottom portion of the first article molded in step B are engaged; sealing said top portion and said bottom portion of said first article together whereby said first article is formed; injection molding a top portion of a second article in said third top station; and injection molding a bottom portion of said second article in said third bottom station;
D. separating said top station from said bottom station and ejecting said first article from said apparatus;
E. disposing said top and bottom assemblies in said first configuration so that the top portion and the bottom portion of said second article molded in step C are engaged; sealing said top portion and said bottom portion of said second article together whereby said second article is formed; injection molding a top portion of a third article in said first top station; and injection molding a bottom portion of said third article in said second bottom station; and
F. separating said top station from said bottom station and ejecting said second article from said apparatus.

2. The method of claim 1, wherein the second top station of said top assembly corresponds to a bottom portion of said article to be molded and/or said first bottom station corresponds to a top portion of said article to be molded.

3. The method of claim 1, wherein in step C, sealing said top portion and said bottom portion of said first article together and/or in Step E, sealing said top portion and said bottom portion of said second article together comprises injection molding a sealing material between said top portion and said bottom portion.

4. A hollow overlay molding apparatus comprising:
a top assembly having a first top injection molding station corresponding to a top portion of an article to be molded; a second top injection molding station; and a third top injection molding station corresponding to a top portion of the article to be molded; and
a bottom assembly comprising a first bottom injection molding station; a second bottom injection molding station corresponding to a bottom portion of said article to be molded; and a third bottom injection molding station corresponding to a bottom portion of said article to be molded;
wherein said top assembly and said bottom assembly may be selectably repositioned relative to one another so that the molding apparatus may be disposed in:
a first configuration wherein said first top station is engageable with said first bottom station; said second top station is engageable with said second bottom station; and said third top station is engageable with said third bottom station; and
a second configuration wherein said first top station is engageable with said second bottom station; said second top station is engageable with said third bottom station; and said third top station is engageable with said first bottom station.

5. The apparatus of claim 4, wherein the second top station of said top assembly corresponds to a bottom portion of said article to be molded and/or said first bottom station corresponds to a top portion of said article to be molded.

6. The apparatus of claim 4, wherein at least one of the injection molding stations is a transfer molding station or an insert molding station.
